(19) United States
(12) Patent Application Publication
(10) Pub. No.: US 2024/0389495 A1
(43) Pub. Date: Nov. 28, 2024

(54) SYSTEM AND METHOD FOR DETECTING AN OPERATIONAL STATUS OF A DISC BLADE

(71) Applicant: CNH Industrial America LLC, New Holland, PA (US)

(72) Inventor: Christopher R. Barrick, Morton, IL (US)

(21) Appl. No.: 18/323,923

(22) Filed: May 25, 2023

(51) Int. Cl. A01B 73/04; A01B 76/00; G01D 21/02; G05B 19/4155

(52) U.S. Cl. CPC A01B 73/044; A01B 76/00; G01D 21/02; G05B 19/4155; G05B 2219/45017

(57) ABSTRACT

A control system for an agricultural implement may include a sensor that generates sensor data for a disc blade and a controller communicatively coupled to the sensor and comprising a memory and a processor. The controller performs operations including receive the sensor data from the sensor, determine a trace based on the sensor data, and determine a status of the disc blade based on a comparison of the trace to a target trace. The status includes operational or not operational.

### BACKGROUND

The present disclosure relates to a system and method for detecting an operational status of a disc blade.

Certain agricultural implements include ground engaging tools configured to interact with soil. For example, a tillage implement includes disc blades configured to break up the soil for subsequent planting or seeding operations. Groups of disc blades are arranged in gangs, and each gang of disc blades is rotatably coupled to a frame of the tillage implement. During operation, the disc blades may crack, break, or fall off due to repeated contact with the soil and/or objects deposited within the soil. Operation with one or more broken/missing disc blades may result in uneven tillage, which may delay the planting or seeding operations and/or reduce crop yield. In certain instances, broken/missing disc blades are detected by manual inspection performed by an operator, which is time-consuming since the operation is stopped for a period of time.

### BRIEF DESCRIPTION

In certain embodiments, a control system for an agricultural implement may include a sensor that generates sensor data for a disc blade and a controller communicatively coupled to the sensor and comprising a memory and a processor. The controller performs operations including receive the sensor data from the sensor, determine a trace based on the sensor data, and determine a status of the disc blade based on a comparison of the trace to a target trace. The status includes operational or not operational.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a tillage implement having a detection system;

FIG. 2 is a close up view of the detection system of FIG. 1;

FIG. 3 is a close up view of the detection system of FIG. 1;

FIG. 4 is a close up view of the detection system of FIG. 1; and

FIG. 5 is a flowchart of an embodiment of a method for operating the detection system to detect a status of a disc blade.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming involves tilling the soil of a field prior to planting seeds. Typically, tillage of soil is accomplished via a work vehicle (e.g., tractor) towing a tillage implement across the field. The tillage implement is equipped with several disc blades (e.g., discs) which engage the soil while being pulled across the field, thereby tilling (e.g., plowing) the soil. The tillage implement may be at least partially automated so as to till soil at least partially independently of human control. During the tilling process, the disc blades of the tillage implement may be impaired (e.g., broken, chipped, bent, missing) as a result of contact with the soil and/or objects (e.g., rocks, roots) deposited within the soil. Accordingly, in certain embodiments disclosed herein, the tillage implement is outfitted with a detection system to determine sudden (e.g., instantaneous) impairment caused by the soil and/or the objects within the soil, thereby improving operation efficiency. The detection system uses sensor data received from one or more sensors to determine a status (e.g., operational, not operational) of the disc blades. For example, the detection system may determine a trace indicative of a profile (e.g., outline, shape, contour) of a disc blade and compare the trace to a target trace. The target trace may be indicative of a profile of an operational disc blade (e.g., disc blade without impairement). In certain instances, the signals output by the one or more sensors may include a pattern (e.g., oscillation). The detection system may determine a trace based on the sensor signal and compare the trace to a target trace. For example, the detection system may determine that the trace is greater than the threshold trace, which may be indicative of a broken, deformed, and/or warped disc blade. In other example, the signal output by the one or more sensors may be absent. The detection system may not determine a trace from the signal, which is indicative of a missing disc blade. In response to determining a difference between the trace and the target trace is greater than a threshold, the detection system outputs a control signal to stop operation. In this way, the detection system reduces or eliminates uneven tillage during the operation.

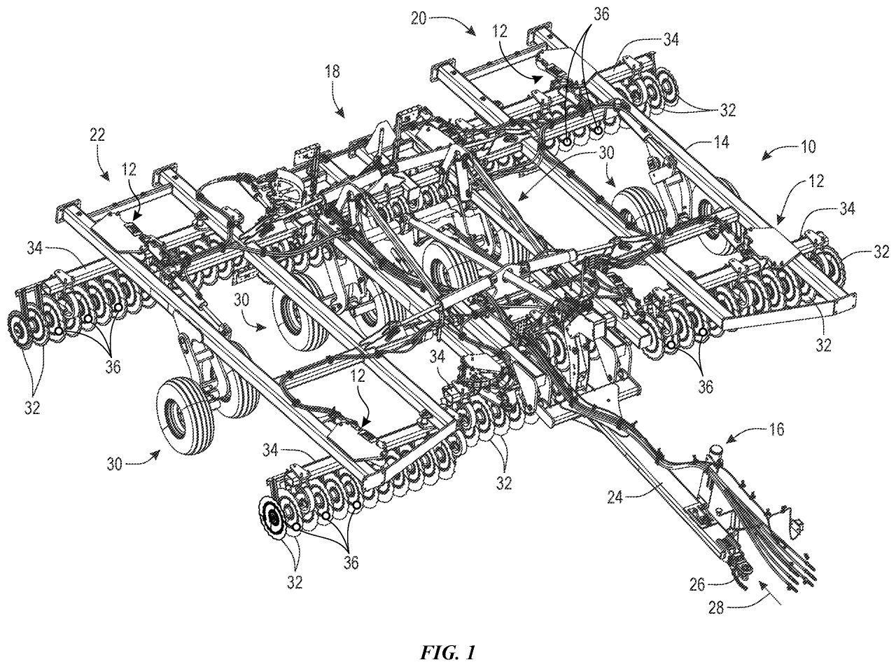

With the foregoing in mind, FIG. 1 is a perspective view of an embodiment of a tillage implement 10 having a detection system 12. In the illustrated embodiment, the tillage implement 10 is a vertical tillage implement having multiple ground engaging tools configured to till soil. As illustrated, the tillage implement 10 includes a frame 14 and a hitch assembly 16 coupled to the frame 14. In the illustrated embodiment, the frame 14 includes a center section 18, a left wing section 20, and a right wing section 22. Each wing section is configured to rotate upwardly from the illustrated working position to a transport position to facilitate transport of the tillage implement 10. For example, one or more actuators (e.g., hydraulic cylinder(s), etc.) may be configured to drive each wing section to rotate between the illustrated working position and the transport position. While the frame 14 includes the center section 18, the left wing section 20, and the right wing section 22 in the illustrated embodiment, in other embodiments, the frame may include more or fewer sections. For example, in certain embodiments, the frame may be substantially rigid (e.g., not including any translatable and/or rotatable components). Furthermore, the frame 14 may be formed from multiple frame elements (e.g., rails, tubes, braces, etc.) coupled to one another (e.g., via welded connection(s), via fastener(s), etc.).

In the illustrated embodiment, the hitch assembly 16 includes a hitch frame 24 and a hitch 26. The hitch frame 24 is pivotally coupled to the implement frame 14 via pivot joint(s), and the hitch 26 is configured to couple to a corresponding hitch of a work vehicle (e.g., tractor), which is configured to tow the tillage implement 10 through a field along a direction of travel 28. While the hitch frame 24 is pivotally coupled to the implement frame 14 in the illustrated embodiment, in other embodiments, the hitch frame may be movably coupled to the implement frame by a linkage assembly (e.g., four bar linkage assembly, etc.) or another suitable assembly/mechanism that enables the hitch to move along a vertical axis relative to the implement frame, or the hitch frame may be rigidly coupled to the implement frame.

As illustrated, the tillage implement 10 includes wheel assemblies 30 movably coupled to the implement frame 14. In the illustrated embodiment, each wheel assembly 30 includes a wheel frame and a wheel rotatably coupled to the wheel frame. The wheels of the wheel assemblies 30 are configured to engage the surface of the soil, and the wheel assemblies 30 are configured to support at least a portion of the weight of the tillage implement 10. In the illustrated embodiment, each wheel frame is pivotally coupled to the implement frame 14, thereby facilitating adjustment of the vertical position of the respective wheel(s). However, in other embodiments, at least one wheel frame may be movably coupled to the implement frame by another suitable connection (e.g., sliding connection, linkage assembly, etc.) that facilitates adjustment of the vertical position of the respective wheel(s).

In the illustrated embodiment, the tillage implement 10 includes disc blades 32 configured to engage a top layer of the soil. As the tillage implement 10 is towed through the field, the disc blades 32 are driven to rotate, thereby breaking up the top layer of the soil. In the illustrated embodiment, the disc blades 32 are arranged in two rows. However, in other embodiments, the disc blades may be arranged in more or fewer rows (e.g., 1, 3, 4, 5, 6, or more). Furthermore, in the illustrated embodiment, each row of disc blades 32 includes four gangs of disc blades 32. Two gangs of disc blades of the front row are coupled to the center section 18, two gangs of disc blades of the rear row are coupled to the center section 18, one gang of disc blades of the front row is coupled to the left wing section 20, one gang of disc blades of the rear row is coupled to the left wing section 20, one gang of disc blades of the front row is coupled to the right wing section 22, and one gang of disc blades of the rear row is coupled to the right wing section 22. While the tillage implement 10 includes eight gangs of disc blades 32 in the illustrated embodiment, in other embodiments, the tillage implement may include more or fewer gangs of disc blades (e.g., 2, 4, 6, 10, or more). Furthermore, the gangs of disc blades may be arranged in any suitable configuration on the implement frame.

The disc blades 32 of each gang are non-rotatably coupled to one another by a respective shaft, such that the disc blades 32 of each gang rotate together. The disc blades 32 may include plain disc blade(s), notched disc blade(s), rippled disc blade(s), or a combination thereof. Each shaft is rotatably coupled to a respective disc blade support 34, which is configured to support the gang, including the shaft and the disc blades 32. Furthermore, each disc blade support 34 is pivotally coupled to the frame 14 at a respective pivot point, thereby enabling the disc blade support 34 to rotate relative to the frame 14. Rotating the disc blade support 34 relative to the frame 14 controls the angle between the respective disc blades 32 and the direction of travel 28, thereby controlling the interaction of the disc blades 32 with the top layer of the soil. Each disc blade support 34 may include any suitable structure(s) configured to support the respective gang (e.g., including a square tube, a round tube, a bar, a truss, other suitable structure(s), or a combination thereof). While the disc blades 32 supported by each disc blade support 34 are arranged in a respective gang (e.g., non-rotatably coupled to one another by a respective shaft) in the illustrated embodiment, in other embodiments, at least a portion of the disc blades 32 supported by at least one disc blade support 34 (e.g., all of the disc blades 32 supported by the disc blade support 34) may be arranged in another suitable configuration (e.g., individually mounted and independently rotatable, mounted in groups and individually rotatable, etc.). For example, in certain embodiments, a first portion of the disc blades 32 supported by a disc blade support 34 may be arranged in a gang, and a second portion of the disc blades 32 supported by the disc blade support 34 may be individually mounted and independently rotatable. Furthermore, in certain embodiments, at least one disc blade support 34 may be non-rotatably coupled to the frame 14 (e.g., such that the disc blades 32 coupled to the disc blade support 34 are oriented at a fixed angle). In addition, in certain embodiments, one or more disc blades 32 may be directly coupled to the frame 14 of the tillage implement 10.

In the illustrated embodiment, the detection system 12 includes one or more sensors 36 each coupled to a locality proximate to the disc blades 32. The sensor(s) 36 may include capacitive sensor(s), optical sensor(s), light detection and ranging (LIDAR) sensor(s), proximity sensor(s), ultrasound sensor(s), radar sensor(s), sonar sensor(s), or any combination thereof. Each sensor 36 may be coupled to the frame 14. the disc blade support 34, or some other structure located near the disc blades 32. Each sensor 36 is configured such that a signal transmitted from the sensor 36 intersects with a portion of at least one disc blade 32, such as an edge of the disc blade 32. For example, the sensor 36 may be a proximity sensor that transmits a first signal to the edge of the disc blade 32 and receives a second signal reflected off the edge of the disc blade 32. In another example, the sensor 36 may be an optical sensor that generates image data of the disc blade 32, such as a profile of the disc blade 32, an outline of the disc blade 32, a trace of the disc blade 32, and the like. The sensor 36 may transmit the signal over a period of time to capture one or more rotations of the disc blade 32 to facilitate determination of a status of the disc blade 32.

In certain instances, the sensors 36 are configured such that one sensor 36 monitors and facilitates determination of a status of one disc blade 32. For example, the sensor 36 may be coupled to a locality proximate to the disc blade 32, such as the frame 14, the disc blade support 34, or the like. The sensor 36 may generate sensor data corresponding to the disc blade 32 to facilitate determination of the status (e.g., operational, not operational). In other instances, the sensors 36 may be configured such that one sensor 36 monitors and facilitates determination of the status of multiple disc blades 32. For example, the sensor 36 may be rotatably coupled (e.g., directable to each disc blade 32) proximate to the disc blades 32 and generate sensor data corresponding to each of the disc blades 32. In another example, the sensor 36 may be configured such that a field of view of the sensor 36 covers multiple disc blades 32. As such, the sensor 36 may simultaneously monitor and facilitate determination of the status of multiple disc blades 32. Still in another instance, multiple sensors 36 may be configured to monitor and facilitate determination of the status of one disc blade 32. Accordingly, any suitable sensor 36/disc blade 32 combination may be used to determine statuses of the disc blades 32. The sensor 36 and disc blade 32 configurations may also be used to determine the status of disc blades 32 within a gang of disc blades 32. For example, one sensor 36 may first monitor disc blades 32 within a first gang of disc blades 32, rotate to subsequently monitor disc blades 32 within a second gang of disc blades 32, and so on. As such, gangs of the disc blades 32 may be periodically monitored, which may improve efficiency of the detection system 12.

While the illustrated embodiment implements the detection system 12 for a tillage implement 10 with disc blades 32, the detection system 12 may also be included with other implements, such as implements using straight coulter disc blades, seeder discs, planter discs, opener discs, closing discs, and the like. Moreover, the detection system 12 described herein may be installed in both new and existing implements. Installation of the detection system 12 includes disposing one or more sensors 36 within a locality proximate to the disc blades 32, such as the frame 14, the disc blade support 34, and the like. The sensors 36 may be secured via various interface and mounting features, such as fasteners, tab extensions, etc. As discussed herein, the sensors 36 may generate and transmit sensor data indicative of a profile of each monitored disc blade 32 to a controller to determine a status of the disc blades 32, which may be indicative of abrupt, instantaneous impairment to the disc blades 32.

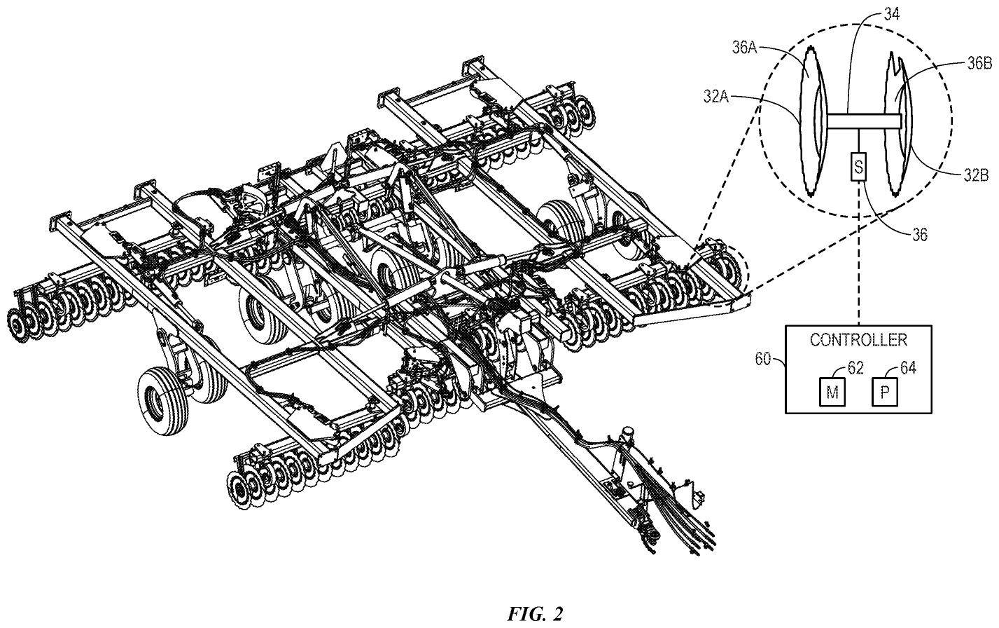

FIG. 2 is a close up view of the detection system 12 of FIG. 1. The detection system 12 includes one or more sensors 36 coupled to the frame 14, the disc blade support 34, or any other support in the proximity of the disc blades 32, and the detection system 12 includes a controller 60 configured to receive a signal from each sensor 36 indicative of sensor data for one or more disc blades 32. The controller 60 receives the sensor data and is configured to determine a status (e.g., operational, not operational) of each monitored disc blade 32 based on the sensor data. To this end, the controller 60 includes a memory 62 and a processor 64 (e.g., a microprocessor). The controller 60 is also communicatively coupled to the sensor 36 and, in certain embodiments, may be configured to control operation of the sensor 36 (e.g., turn the sensor on/off, adjust sensor settings, control rotation of the sensor, etc.). Moreover, the processor 64 may include multiple microprocessors, one or more “general-purpose” microprocessors, one or more special-purpose microprocessors, and/or one or more application specific integrated circuits (ASICS), or some combination thereof. For example, the processor 64 may include one or more reduced instruction set (RISC) or complex instruction set (CISC) processors. The memory 62 may include a volatile memory, such as random access memory (RAM), and/or a nonvolatile memory, such as read-only memory (ROM).

The memory 62 may store a variety of information and may be used for various purposes. For example, the memory 62 may store processor-executable instructions (e.g., firmware or software) for the processor 64 to execute, such as instructions for determining statuses of the disc blades 32. In another example, the memory 62 may store one or more target traces of the disc blades 32. The target traces may be indicative of a profile of the disc blade 32. For example, the target trace may include a target value or parameter. Each target trace may correspond to a type of disc blade 32, a size of the disc blade 32, a surface texture of the disc blade 32, a portion of the disc blade 32, or the like. For example, the disc blades 32 of tillage implements 10 may be curved such that one surface is convex and an opposite surface is concave. A first target trace for a first surface of the disc blade 32 and a second target trace for a second surface of the disc blade 32 may be generated and/or stored. In another example, the disc blade 32 may be straight without any curvature. The target trace may be generated and/or stored for the straight disc blade 32. Moreover, the disc blades 32 may not be uniform in size and/or the detection system 12 may be used for multiple different types of disc blades 32. As such, the memory 62 may store one or more target traces associated with one or more types of disc blades 32. The memory 62 and/or the processor 64, or an additional memory and/or processor, may be located in any suitable portion of the tillage implement or, in some embodiments, a work vehicle towing the tillage implement.

In the illustrated embodiment, the detection system 12 includes sensor 36, and the controller 60 is configured to determine a status of a first disc blade 32A and a status of a second disc blade 32B. For example, the sensor 36 is rotatably coupled to the disc blade support 34 and configured to generate sensor data for the first disc blade 32A the second disc blade 32B. The sensor 36 may be directed to the first disc blade 32A, generate and output sensor data for the first disc blade 32A to the controller 60, and the controller 60 may determine the status of the first disc blade 32A based on the sensor data. The controller 60 may output a control signal to cause the sensor 36 to rotate (e.g., via an actuator) to enable the sensor 36 to generate and output sensor data for the second disc blade 32B. In another example, the sensor 36 may be an inductive sensor that monitors a change in electromagnetic field of the first disc blade 32A and the second disc blade 32B, respectively. Still in another example, the sensor 36 may be an optical sensor configured to direct a field of view at the first disc blade 32A and the second disc blade 32B. The field of view is configured to intersect an outer edge of the disc blades 32. Additionally, the sensor 36 is configured to capture multiple rotations of the disc blades 32, which may be representative of the outer edges of the disc blades 32. The controller 60 may be configured to employ image analysis techniques and/or machine learning techniques (e.g., segmentation, k-means clustering, neural networks, etc.) to identify and locate an edge of each disc blade 32 and, in certain instances, create an image representative of the outer edge of the disc blade 32.

The controller 60 determines a status of the first disc blade 32A and the second disc blade 32B based on the sensor data. For example, the controller 60 may determine the status of first disc blade 32A by determining a trace representative of the first disc blade 32A based on the sensor data. As illustrated, the first disc blade 32A is circular without any impairments. For example, the sensor data may include image data of an outer edge the first disc blade 32A and the trace may correspond to the image of an outer edge or a model of the outer edge of the first disc blade 32A. The controller 60 compares the trace to a target trace. For example, the target trace may include an image of the outer edge of an intact disc blade or a model of the outer edge of the intact disc blade. The controller 60 may determine a difference between the trace and the target trace. If the difference is less than a threshold, the controller 60 may determine the status of the disc blade 32 is operation. If the different is greater than a threshold, the controller 60 may determine the status of the disc blade 32 is not operation. In certain instance, the controller 60 may transmit a signal to stop operation if any disc blade 32 is determined to be not operational. As illustrated, the first disc blade 32A is intact and the controller 60 may determine the difference between the trace and the target trace is below a threshold.

The controller 60 may also determine the status of the second disc blade 32B. As illustrated, an edge of the second disc blade 32B is chipped, broken, and/or cracked (e.g., from repeated contact with the soil and/or objects within the soil during operation). Such impairment may occur abruptly or instantaneously. For example, a rock may impact the second disc blade 32B. Due to the impairment, the sensor data may include a pattern, such as a cyclical or periodical change in the magnitude of the sensor signal. In another example, the sensor data may include image data indicative of the second disc blade 32B, which may include an uneven profile of the second disc blade 32B. The controller 60 may determine a trace representative of the second disc blade 32B based on the sensor data. The controller 60 may compare the trace to a target trace associated with the second disc blade 32B and determine a difference between the trace and the target trace is greater than a threshold. Based on the difference being greater than the threshold, the controller 60 may determine the status of the second disc blade 32B is not operational. The controller 60 may transmit a signal to stop operation of the tillage implement due to the second disc blade status 32B being not operation.

In certain embodiments, the disc blades 32 may be divided into sections, such that the detection system 12 is configured to determine a status for each disc blade 32 of a first section of disc blades 32, each disc blade 32 of a second section of disc blades 32, and so on. The status determination is made over a period of time, such as 10 seconds, 20 seconds, 30 seconds, 1 minute, 5 minutes, or any suitable amount of time. For example, the period of time may be an amount of time for the sensor 36 to generate sensor data of one or more rotations of the disc blade 32 during operation. Capturing multiple rotations of the disc blade 32 may create a robust data set for determining the status of the disc blade 32. Further, the sensor 36 may be configured to generate sensor data for portions of each disc blade 32 as the disc blade rotates to improve detection efficiency. For example, the sensor 36 may be positioned to capture half of the disc blade 32. As the disc blade 32 rotates during operation, the sensor 36 may capture a full profile of the disc blade 32. In another example, a field of view of the sensor 36 may be blocked by objects, the frame 14, the disc blade support 34, or the like. The field of view may be a portion of an outer edge of the disc blade 32. However, capturing multiple rotations of the disc blade 32 provides a representation of the outer edge of the disc blade 32. As such, capturing multiple rotations of the disc blade 32 may facilitate generation of a full profile of the outer edge of the disc blade 32, which may be used to determine the status of the disc blade 32. By dividing the disc blades 32 into sections, the sensor 36 may provide the controller 60 with information for each disc blade 32 within the tillage implement. For example, the controller 60 may transmit a control signal to the actuator coupled to the sensor 36 to direct the sensor 36 to each section. In this way, the detection system 12 may determine the status of each disc blade 32 within the section and/or multiple sections.

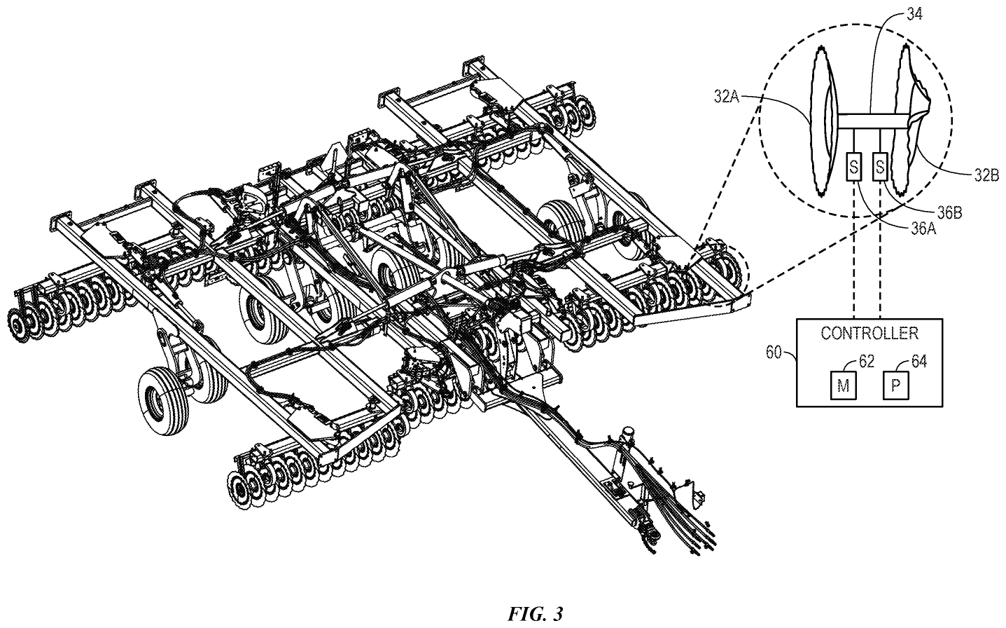

FIG. 3 is a close up view of the detection system 12 of FIG. 1. In the illustrated embodiment, the detection system 12 includes two sensors 36 coupled to the frame 14, the disc blade support 34, or any other support in the proximity of the disc blades 32, and the controller 60 is configured to determine a status of the disc blades 32. As illustrated, the status of the first disc blade 32A may be operational, while the status of the second disc blade 32B may be not operational. The second disc blade 32B may become deformed (e.g., bent, warped, oblong) due to contact with the soil and/or objects within the soil. The detection system 12 includes a first sensor 36A configured to generate sensor data for the first disc blade 32A and a second sensor 36B configured to generate sensor data for the second disc blade 32B, or vice versa.

By way of example, the first sensor 36A may be an optical sensor and the second sensor 36B may be a proximity sensor. The first sensor 36A may generate sensor data indicative of image data of the first disc blade 32A and the second sensor 36B may generate sensor data for the second disc blade 32B. The controller 60 may determine a status of the first disc blade 32A and the second disc blade 32B based on the sensor data. For example, the controller 60 may determine a first trace for the first disc blade 32A based on sensor data from the first sensor 36A. The controller 60 may determine a difference between the first trace to a target trace and compare the difference to a threshold. The controller 60 may determine the difference is below a threshold, which indicates the first disc blade 32A is operational. The controller 60 may also determine a second trace for the second disc blade 32B based on sensor data from the second sensor 32B. Due to the bending within the second disc blade 32B, the sensor data may include oscillating values/parameters, as such the trace include oscillating values or parameters. The controller 60 may determine a difference between the second trace and the target trace is above a threshold, which indicates the second disc blade 32B is not operational.

In certain embodiments, the controller 60 may be configured to receive multiple sensor data over a period of time from the first sensor 36A and the second sensor 36B. For example, the controller 60 may receive sensor data from the first sensor 36A for the first disc blade 32A and sensor data from the second sensor 36B for the first disc blade 32A. The use of different types of sensor data and/or sensor data from different sensors may create a robust data set for the controller 60 to determine the status of the first disc blade 32A. The controller 60 may determine the status based on sensor data from the first sensor 36A and/or verify the status based on sensor data from the second sensor 36B, or vice versa. In this way, accuracy in determining the status may be enhanced. While the illustrated example includes two sensors, the controller 60 may receive sensor data from any suitable number of sensors, such as 3 or more, 4 or more, 5 or more, 10 or more, and so on.

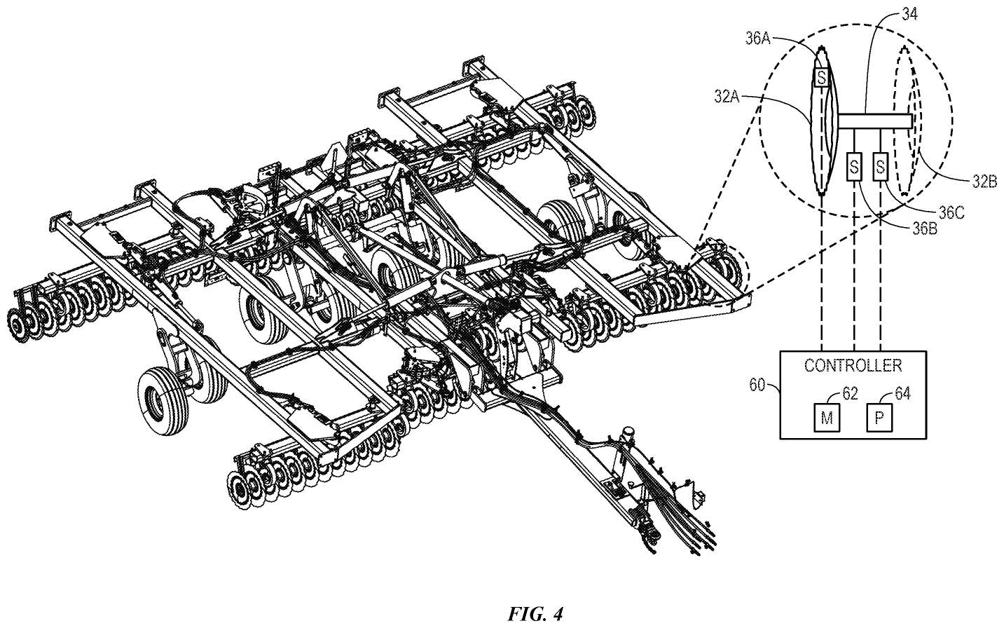

FIG. 4 is a close up view of the detection system 12 of FIG. 1. The detection system 12 may include multiple sensors 36 coupled to the frame 14, the disc blades 32, the disc blade support 34, and the controller 60 is configured to receive sensor data. For example, a first sensor 36A is coupled to the first disc blade 32A, and a second sensor 36B and a third sensor are coupled to the disc blade support 34. Each of the sensors 36 is configured to generate sensor data for the first disc blade 32A and the second disc blade 32B. As illustrated, the status of the first disc blade 32A is operational, while the status of the second disc blade 32B is not operational. For example, the second disc blade 32B may have disengaged the implement frame during operation due to contact with the soil and/or objects within the soil. Continuously operating with a missing disc blade 32 may result in untilled soil, which may delay subsequent planting or seeding operations and/or reduce crop yield.

The detection system 12 may detect the missing disc blade (e.g., second disc blade 32B) when determining the status of the disc blades 32 over a period of time. For example, the first sensor 36A may be a LIDAR sensor directed at a body of the first disc blade 32A and/or the second disc blade 32B, the second sensor 36B may be a capacitive sensor directed at an outer edge of the first disc blade 32A and/or the second disc blade 32B, and the third sensor 36C may be an optical sensor directed at a portion of the first disc blade 32A and/or a portion of the second disc blade 32B. Use of low-cost sensors may reduce costs for implementing the detection system 12 while providing adequate sensor data for the determination.

In certain embodiments, the controller 60 may use a set of data from one of the sensors 36 to determine the status. The controller 60 may receive preferences and/or determine preferences (e.g., high detail, low detail, high level, low level) for determining the status. For example, an operator may specify or the controller 60 may determine (e.g., via machine learning) that the status determination be made using high-level, low resolution sensor data to improve efficiency of the detection. To this end, the controller 60 may use sensor data from the second sensor 36B (e.g., capacitive sensor) to determine the status, which may decrease processing time for the controller 60. In another example, the operator may specify or the controller 60 may determine that the status determination be made using high resolution data to improve accuracy of the determination, which may improve efficiency of the operation. As such, the controller 60 may use sensor data from an optical sensor and/or a LIDAR sensor as well as image processing techniques and/or machine learning techniques to process the sensor data. The processing time may increase, but the accuracy of the status determination may increase.

In another embodiment, the controller 60 may determine the status of the disc blades 32 using the multiple sets of sensor data. In certain instances, the controller 60 may first analyze high level (e.g., least granular) sensor data, such as sensor data from the second sensor 36B (e.g., capacitive sensor). For example, the sensor data from the capacitive sensor may be less complex and/or use less processing in comparison to sensor data from the optical sensor. As such, the controller 60 may perform a first pass to determine statuses of the disc blades 32 based on the sensor data from the second sensor 36B, which may improve operation efficiency. For example, the controller 60 may determine a first trace based on the sensor data for the first disc blade 32A, compare the first trace to the target trace, and determine the difference is less than or equal to a threshold. As discussed herein, the target trace is indicative of an intact disc blade. In addition, the controller 60 may determine a second trace based on the sensor data for the second disc blade 32B, compare the second trace to the target trace, and determine the difference is greater than the threshold. Due to the second disc blade 32B being missing, the sensor data may be absent. The controller 60 may determine the second trace indicative of an absent disc blade 32B, thereby establishing a difference between the second trace and the target trace being greater than the threshold. Accordingly, the status of the first disc blade 32A is operational while the status of the second disc blade 32B is not operational. In certain instances, the controller 60 may determine the sensor data for the second disc blade 32B indicates a missing disc blade, such as based on image analysis or machine learning techniques, and determine a not operational status without determining the second trace. In other instances, the controller 60 may identify the sensor data as being absent and determine the not operational status without determining the second trace. In this way, the operation efficiency may be improved. Additionally or alternatively, the controller 60 may output a control signal to stop operation of the tillage implement, which may reduce or eliminate untilled soil during the tillage operation.

In other instances, the controller 60 may analyze a second set of sensor data with increased granularity to verify the status of the second disc blade 32B. For example, the controller 60 may use sensor data from the first sensor 36A (e.g., LIDAR sensor) and image processing techniques to determine and/or verify the status of the second disc blade 32B. The controller 60 may process the sensor data using image analysis techniques and/or machine learning to identify the missing disc. Indeed, the controller 60 may not fit a curve or a circle to the sensor data, which may is indicative of a missing disc blade. Additionally or alternatively, the controller 60 determine the second trace based on the sensor data and compare the second trace to the target trace. The controller 60 may determine the difference is greater than the threshold and determine that the second disc blade 32B is missing. In response to the verification and/or the determination, the controller 60 may output the control signal to stop operation of the tillage implement.

Still in another instance, the controller 60 may analyze a third set of sensor data to verify the status of the second disc blade 32B. For example, the controller 60 may use sensor data from the third sensor 32C (e.g., optical sensor) and machine learning techniques to verify and/or determine the status of the second disc blade 32B. Indeed, the controller 60 may process the sensor data and determine that the second disc blade 32B is missing. As such, the controller 60 may output the control signal to stop operation of the tillage implement. Additionally or alternatively, the controller 60 may verify the status of the first disc blade 32A using the second set of sensor data and/or the third set of sensor data. By verifying the status using multiple sets of sensor data, the controller 60 may enhance the accuracy of the status determination.

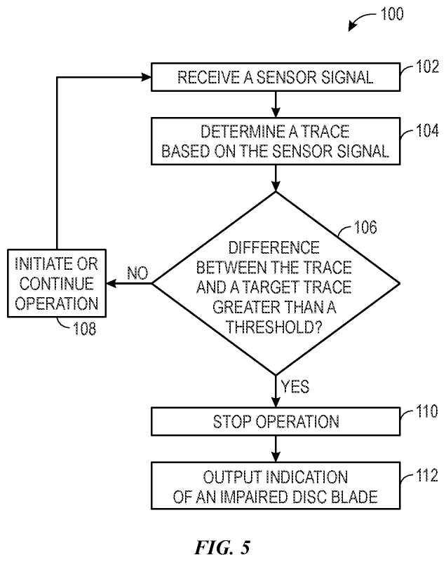

FIG. 5 is a flowchart of an embodiment of a method 100 for operating the detection system to detect a status of the disc blades. For example, the detection system may include any suitable number of sensors coupled to a locality proximate the disc blades and the controller configured to determine a status of each monitored disc blade based on the sensor data and a target trace.

At block 102, the controller receives sensor signal(s) indicative of sensor data for one or more disc blades. The controller is configured to receive the sensor data from one or more sensors within the tillage implement. The sensor data may include monitored parameters/values, LIDAR data for one disc blade, an image of one disc blade, other suitable data, or a combination thereof. In certain instances, the sensor data may include an image of multiple disc blades, LIDAR data for multiple disc blades, other suitable data, or a combination thereof.

At block 104, the controller determines a trace based on the sensor signal. For example, the sensor data may be indicative of an operational disc blade and the trace may include a constant value or parameter. The sensor data may include image data of a profile of the disc blade. The controller may use image processing techniques and/or machine learning techniques to fit a circle and/or a curve to the image data to determine the trace. In another example, the sensor data may be indicative of a not operational disc blade and the trace may include an oscillating value or parameter. In an instance, the controller may determine a frequency and/or a magnitude of the trace based on the sensor signal.

At block 106, the controller determines if a difference between the trace and a target trace is greater than a threshold. The target trace may be determined based on user input characteristics. For example, the controller may determine and/or receive user input of characteristics of the disc blade, such as a type, a size, a shape, and so on. For example, the disc blade may be a rippled or notched disc blade. As such, the target trace may include oscillations for a rippled or notched disc blade. Determine the difference between the trace and the target trace may include determining the oscillations do not match. In this way, the controller is configured to retrieve the threshold trace based on the characteristics. In another example, the tillage implement may use one type of disc blades. As such, the memory may store one target trace corresponding to the disc blades. The controller determines a difference between the trace to the target trace by comparing the constant value or parameter of the trace to the constant value or parameter of the target trace.

If the difference between the trace and the target trace is not greater than the threshold, the controller outputs a control signal to initiate or continue operation at block 108. That is, the controller determines the status of the disc blade is operational. In an instance, the controller may not output a control signal and the operation may continue. In other instances, the controller may output a control signal to initiate operation of the tillage implement. The method 100 may return to block 102 to receive sensor data to determine the status of the disc blades.

If the difference between the trace and the target trace is greater than the threshold, then the controller outputs a control signal to stop operation at block 110. For example, the disc blade may be impaired (e.g., chipped, broken, bent, missing) during the operation, and the controller may determine the status of the disc blade is not operational. As such, the controller outputs a control signal to stop the tillage operation, which may reduce or eliminate untilled soil. In certain embodiments, the controller may not output the control signal. Instead, the method 100 may skip to block 112, and the controller may output an indication of an impaired disc blade.

At block 112, the controller outputs an indication of an impaired disc blade. For example, the controller may cause a light to flash, a popup to be displayed on a screen, an alarm to sound, and the like. The controller may indicate a location of the impaired disc blade within the tillage implement. In this way, the detection system may notify the operator that impairment to the disc blades has occurred. Additionally or alternatively, the controller may cause a wing section with the impaired disc blade to be lifted to remove the disc blade from the tilling operation. As such, the operator may quickly locate and switch out the impaired disc blade, then continue the tillage operation. In other instances, the operate may indicate to lift the wing section including the impaired disc blade and continue operations.

The method described above may be stored on one or more tangible, non-transitory, machine-readable media and/or may be performed by the processor of the controller described above with reference to FIGS. 2-4 and/or on other suitable controller(s). The steps of the method 100 may be performed in the order disclosed above or in any other suitable order. Furthermore, certain steps of the method may be omitted.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A control system for an agricultural implement, the control system comprising:
a sensor configured to generate sensor data for a disc blade; and
a controller communicatively coupled to the sensor and comprising a memory and a processor, wherein the controller is configured to:
receive the sensor data from the sensor;
determine a trace based on the sensor data; and
determine a status of the disc blade based on a comparison of the trace to a target trace, wherein the status comprises operational or not operational.

2. The control system of claim 1, wherein the controller is configured to output a control signal to stop operation of the agricultural implement in response to determining the status is not operational.

3. The control system of claim 2, wherein the controller is configured to transmit an indication of a location of the disc blade.

4. The control system of claim 2, wherein the controller is configured to compare of the trace to the target trace by:
determining a difference between the trace and the target trace; and
determining the difference is greater than a threshold.

5. The control system of claim 1, wherein the controller is configured to output a control signal to initiate operation of the agricultural implement or continue operation of the agricultural implement in response to determining the status is operational.

6. The control system of claim 1, comprising a second disc blade, wherein the sensor is configured to generate second sensor data indicative of the second disc blade.

7. The control system of claim 5, wherein the controller is configured to:
determine a second trace based on the second sensor data; and
determine a status of the second disc blade is operational based on a comparison of the second trace to the target trace, wherein the comparison is less than a threshold.

8. The control system of claim 1, wherein the sensor is directed to an outer edge of the disc blade, and wherein the sensor data comprises measurements over a plurality of rotations of the disc blade.

9. The control system of claim 1, wherein the controller is configured to:
determine the status is not operational; and
output a control signal to notify an operator of the status.

10. A method for determining a status of a disc blade of a tillage implement, the method comprising:
receiving, via a processor, a sensor signal indicative of the disc blade from a sensor;
determining, via the processor, a trace based on the sensor signal; and
determining, via the processor, the status of the disc blade based on a comparison of the trace to a target trace, the status comprises operational or not operational.

11. The method of claim 10, comprising transmitting, via the processor, a control signal indicative of initiating operation using the disc blade in response to determining the status of the disc blade is operational.

12. The method of claim 10, comprising, transmitting, via the processor, a control signal indicative of lifting a wing section with the disc blade in response to determining the status of the disc blade is not operational.

13. The method of claim 10, comprising transmitting, via the processor, an indication comprising a location of the disc blade in response to determining the status of the disc blade is not operational.

14. The method of claim 10, comprising:
receiving, via the processor, a second sensor signal indicative of a second disc blade from the sensor;
determining, via the processor, a second trace based on the second sensor signal; and
determining, via the processor, the status of the second disc blade is operational based on a comparison of the second trace and the target trace being less than a threshold.

15. A detection system for a tillage implement, comprising:
a sensor configured to direct a field of view at a plurality of disc blades of the tillage implement, wherein the field of view is configured to intersect the plurality of disc blades; and
a controller coupled to the sensor and comprising a memory and a processor, wherein the controller is configured to:
receive sensor data from the sensor indicative of the plurality of disc blades;
determine a trace for each of the plurality of disc blades based on the sensor data; and
determine an operational status of each of the plurality of disc blades based on comparison between a respective trace and a target trace.

16. The detection system of claim 15, wherein the sensor data comprises an edge of each of the plurality of disc blades, and wherein the controller is configured to fit a curve to the edge of the each of the plurality of disc blades.

17. The detection system of claim 15, wherein the controller is configured to determine the operational status for each of the plurality of disc blades by:
determine a first trace for a first disc blade of the plurality of disc blades;
determine a difference between the first trace and the target trace;
determine the status of the first disc blade is operational based on the difference being less than a threshold; and
determine the operational status for a second disc blade of the plurality of disc blades in response to the status of the first disc blade being operational.

18. The detection system of claim 15, wherein the controller is configured to output a control signal to raise a wing section comprising a first disc blade of the plurality of disc blades in response to determining the operational status of a first disc blade of the plurality of disc blades is not operational.

19. The detection system of claim 15, wherein the sensor is configured to generate the sensor data over a period of time for a first disc blade of the plurality of disc blades and generate the sensor data over the period of time for a second disc blade of the plurality of disc blades.

20. The detection system of claim 15, wherein the sensor comprises an ultrasonic sensor, a LIDAR sensor, a capacitive sensor, an optical sensor, or a proximity sensor.
